(19) United States
(12) Patent Application Publication
(10) Pub. No.: US 2018/0012084 A1
(43) Pub. Date: Jan. 11, 2018

(54) APPARATUS AND METHOD OF RECOGNIZING DIVISION LINES ON A ROAD

(71) Applicant: DENSO CORPORATION, Kariya-city (JP)

(72) Inventors: Kenji OKANO, Kariya-city (JP); Akinobu SAKAI, Kariya-city (JP); Takamichi TORIKURA, Kariya-city (JP)

(21) Appl. No.: 15/643,350

(22) Filed: Jul. 6, 2017

(30) Foreign Application Priority Data
Jul. 8, 2016 (JP) 2016-136113

(51) Int. Cl. G06K 9/00; G06K 9/46

(52) U.S. Cl. CPC G06K 9/00798; G06K 9/46

(57) ABSTRACT

A division line recognition apparatus is provided with a feature detector detecting bright features showing an area which is brighter than a road surface from captured images, and a reflection determination unit which determines straight lines as road surface reflection areas, when the bright feature points are detected in a same position between frames of images captured at a preset period and form a straight line shorter than a preset threshold length, among the detected bright feature points. A white line recognition unit which recognizes a white line from the bright feature points having the bright feature points showing a short line determined as the road surface reflection, removed therefrom.

### CROSS-REFERENCE RELATED APPLICATION

The application is based on and claims the benefit of the priority of earlier Japanese application No. 2016-136113, filed on Jul. 8, 2016, the description of which is incorporated herein by reference.

### BACKGROUND

### Technical Field

The present invention relates to an apparatus and method of recognizing, based on images captured by cameras mounted on a vehicle, division lines, such as white and yellow lines determining a traffic lane on the road on which the vehicle travels.

### Related Art

Various techniques have been recently proposed for automatic travelling of a vehicle in a road lane. In such systems which accomplish the techniques, cameras mounted on the vehicle are used to provide images captured around the vehicle, in order to optically recognize division lines on the road using the captured images. In this case, occasionally, there is a concern that the device may erroneously recognize noise contained in the captured image as a division line.

In order to overcome these drawbacks, various apparatuses which prevent the erroneous recognition of noise as the division line have been proposed. For example, a lane mark recognition device disclosed in JP2015-197829A determines and recognizes existence of a lane mark provided on a road. With this type of device it is important to correctly distinguish division lines which are the lane marks from noise. The noise here includes repair marks which remain after repairing lane marks, for example, which are normally undesirable when detecting of the division lines on the road. The lane mark recognition device disclosed in JP2015-197829A recognizes such repair marks as a type of noise existing close to the lane mark, by reference of lower luminescence of the repair marks on the image, to prevent erroneous recognition.

On the other hand, incident light in a camera lens which is reflected from a road surface may also be contained in an image as noise. In addition to the division lines, reflections from the road surface also have increased luminance in the image. As a result, the road surface reflections may be erroneously recognized as division lines. Furthermore, road surface reflections are not limited to appearing near to the division line, and their luminance may not necessarily appear lower than the division line on the captured image of the camera. As a result, the device disclosed in patent literature may not distinguish between a road surface reflection and a division line on a road.

### SUMMARY

In view of the above described, an object of the present disclosure is to provide a division line recognition apparatus and method which is capable of determining a road surface reflection and recognize division lines with high precision.

The present disclosure is an apparatus and method of recognizing division lines on the road, from an image taken by a camera mounted on a vehicle. The lane recognition device is provided with a feature point detector, a reflection determination unit, and a division line recognition unit. The feature point detector detects light feature points having pixels whose intensities are higher than a predetermined intensity, and areas which are lighter than remaining areas on the road surface of a captured image. The reflection determination unit determines a straight line as a road surface reflection area, if the straight line, having the bright feature points, is detected in the same position between frames of captured images captured at preset intervals, among the bright features detected by the feature point detector, and if a length of the straight line is shorter than a length of a preset threshold.

A division line consisting of broken lines is detected at different positions between captured frames. In contrast, a division line consisting of straight lines is detected in a same position between the captured frames. Additionally, since a relative position of a camera and light source can be considered constant in a short time, the road surface reflection area in which light is reflected from on a road surface is detected in the same position between frames of the captured image. That is, a feature point detected in the same position between the frames is determined as a feature point indicating either one of the division line of a straight line and the road surface reflection area, and not indicating the division line of the broken line.

In general, from the relative position of the camera and light source, without the road surface becoming a reflected area across an entire forward direction, a length of a road surface reflection is shorter than as straight division line, on an image. More specifically, if the feature point detected in the same position between frames is also a short straight line being shorter than the length of the threshold, the short line is determined as being a road surface reflection area. As a consequence, road surface reflection areas are recognized and division lines can be recognized with high precision.

It is noted that symbols in the summary and claims are used to show a correspondence relation between specific means as a mode described in preferred embodiments, and do not limit a technical range of the present disclosure.

### BRIEF DESCRIPTION OF DRAWINGS

In the accompanying drawings:

FIG. 1 is a block diagram showing a schematic configuration of a division line recognition apparatus;

FIG. 2 is a descriptive diagram showing camera positions;

FIG. 3 is a descriptive diagram showing a white line, a repair mark and a road surface reflection;

FIG. 4 is a descriptive diagram showing a feature of the white line shown as a broken line;

FIG. 5 is a descriptive diagram showing a feature of the white line shown as a solid line;

FIG. 6 is descriptive diagram showing a feature of a road surface reflection;

FIG. 7 is a flow chart showing a process for an outputting recognition result of a white line;

FIG. 8 is a flow chart showing a process for recognition of the white line according to a first embodiment;

FIG. 9 is a descriptive diagram showing detection of a road surface reflection using movement of the feature points and a length of a straight line between frames;

FIG. 10 is a flow chart showing a process method for recognition of a white line according to a second embodiment;

FIG. 11 is a descriptive diagram showing determination of a road surface reflection using an arrangement of dark feature points and bright feature points; and

FIG. 12 is a descriptive diagram showing determination of the road surface reflection using movement of the feature points, the length of a straight line and arrangement of the dark feature points and the bright feature points.

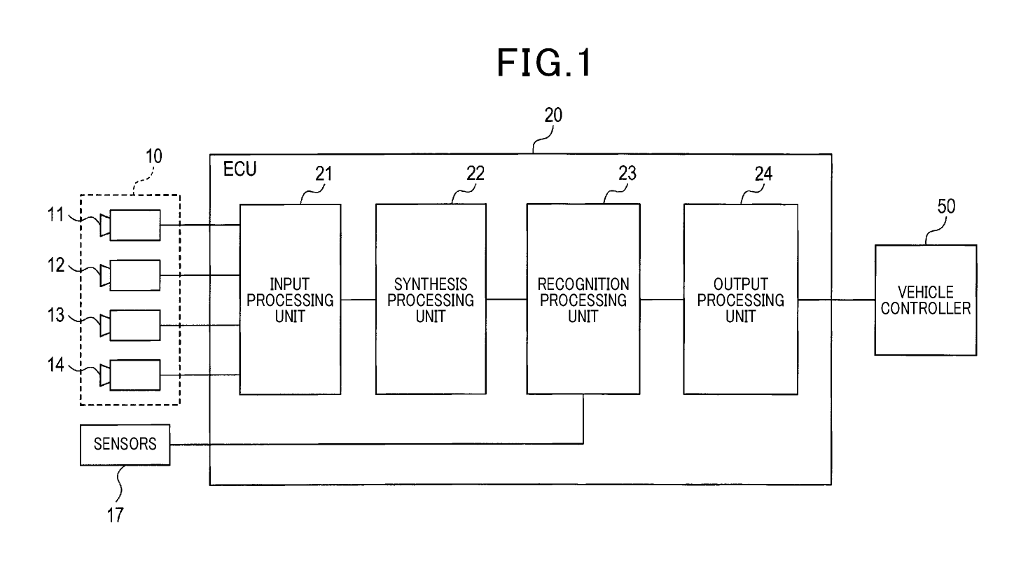

### PREFERRED EMBODIMENTS

A first preferred embodiment of the present disclosure will now be described with reference to drawings.

### First Embodiment

[Configuration]

An apparatus for recognizing division lines on a road is also referred to as a division line recognition apparatus hereon. The division line recognition apparatus according to the first embodiment is an apparatus mounted on a vehicle 70 which recognizes a division line on a road. The division line recognition apparatus according to the first embodiment is configured of an ECU (Electronic Control Unit) 20, a camera 10, sensors 17 and a vehicle controller 50 are connected to the ECU 20. It is noted that the division lines are white lines or yellow lines painted on a road surface indicating a travelling lane. The white lines also include division lines which are colors other than the white, hereinafter.

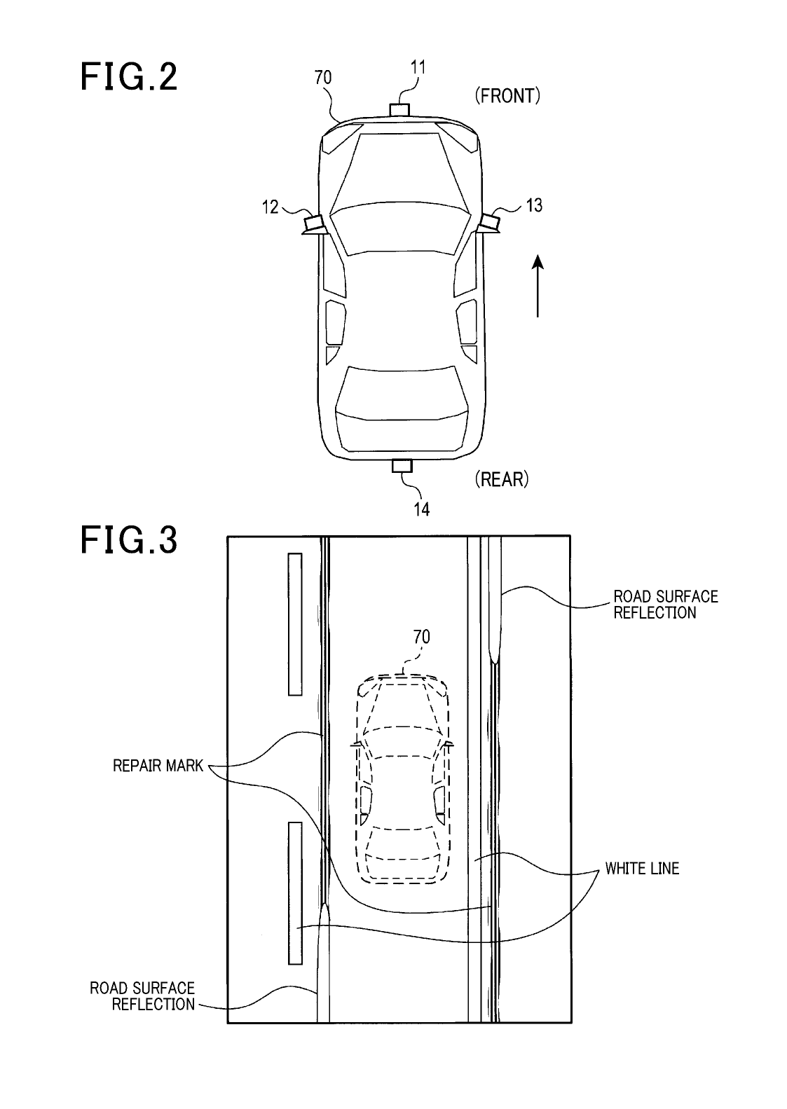

The camera 10 is provided with a front camera 11, a left-side camera 12, a right-side camera 13, and a rear camera 14. Each of the cameras 11 to 14 is configured from a known device, for example, a Charged Coupled Device image sensor (CCD) or a CMOS (Complementary Metal-oxide Semiconductor) device. As shown in FIG. 2, the front camera 11 is disposed on a bumper of each side of the vehicle, for example, so that a road surface in front (F) of a vehicle is a captured range. The left-side camera 12, is disposed on a side mirror on a left side, for example, so that a road surface on a left-side of the vehicle is a captured range. In contrast, the right-side camera 13, is disposed, for example, on a side mirror on a right-side, so that a road surface on a right of the vehicle is a captured range. The rear camera 14 is disposed, for example, on a bumper at a rear end of the vehicle, so that the imaging view range of the rear camera 14 captures a road surface at the rear end (R) thereof.

The sensors 17 measure behavior of the vehicle 70. Specifically, the sensors 17 are a plurality of sensors including a vehicle speed sensor measuring a speed of the vehicle 70 and a yaw rate sensor measuring a yaw rate of the vehicle 70.

The vehicle controller 50 is configured mainly of a known microcomputer provided with a CPU (Central Processing Unit), ROM (Read Only Memory), RAM (Random Access Memory) and a flash memory, for example. The vehicle controller 50 controls steering, a brake, and an engine, for example, of the vehicle 70, so that the vehicle 70 runs in a lane, on a basis of recognition results of the white lines output from the ECU 20.

The ECU 20 is configured mainly of a known microcomputer provided with a CPU, a ROM, a RAM and a flash memory, for example. Each function actualized by the ECU 20 is performed by executing a program stored in a non-transitory recording media. In the example described, a semiconductor memory is a non-transitory recording media storing a program and by executing the program, a method corresponding to the program is executed. It is noted that the microcomputer configuring the ECU 20 may be provided as one or in plurality.

ECU 20 provides steps or processes which functionally actualizes an input processing unit 21, a synthesizing processing unit 22, a recognition processing unit 23 and an output processing unit 24. Additionally, the recognition processing unit 23 is further provided with a feature point detector, a reflection determination unit, and a division line recognition unit. A procedure to implement the elements is not limited to a software, and a part or entirety of the elements may be implemented using hardware combined with logic circuits or analogue circuits.

### [Features of a Road Surface Reflection Area]

In FIG. 3 a schematic view of a bird's eye view image produced by the synthesizing processing unit 22 is shown. An image captured by the cameras is converted into a bird's eye view image according to, for example, a method disclosed in the JP-2014-197749A. In a center of the FIG. 3, a region of a vehicle outline indicated with a broken line is a vehicle region in which the vehicle 70 exists. The synthesizing processing unit 22 synthesizes images taken by the 4 cameras 11 to 14, converts the images to bird's eye view images, and produces a bird's eye view image of a surrounding of the vehicle region incorporated therein.

The bird's eye view image shown in FIG. 3, shows a broken line as a white line, a solid line as a white line, and a repair mark, as feature areas of the road surface. The respective white lines mentioned above are referred to as a broken white line and a solid white line, hereon.

In the first embodiment, areas having a different color from the road surface, for example, lines provided on the road surfaces are classed as feature areas. The repair marks are marks of repaired cracks on the road surface, for example, crack marks on asphalt road surfaces repaired by tar, and crack marks on concrete surfaces repaired by asphalt. The cracks on road surfaces occur frequently along the white lines after receiving tire pressure, particularly in regions which have a lot of snow, such as, North America. In this case the repair marks are often straight lines along the white lines. It is noted that, the bird's eye view image is a captured image in the first embodiment.

The repair marks usually become darker than the road surface in the bird's eye view image. However, when light, for example, sunlight incident on the repair mark is reflected and if the reflected light becomes light incident through a lens of the cameras 10, the reflected area from which the light is reflected, becomes brighter than the road surface in the bird's eye view image. In this way, a feature of the reflection area becoming brighter than the road surface in the image is not limited to a reflection area of the repair mark, but may apply to an entire road surface reflection area. As a consequence, the road surface reflection areas may be erroneously recognized as white lines.

In this regard, in the first embodiment, clarification of a different feature, between the road surface reflection area and the white line area, followed by distinguishing between of the road surface reflection area and the white lines on the bird's eye view image is performed. It is noted that road surface reflection areas other than areas reflected from repair marks, for example, reflections from areas of a wet road surface, may also be road surface reflection areas.

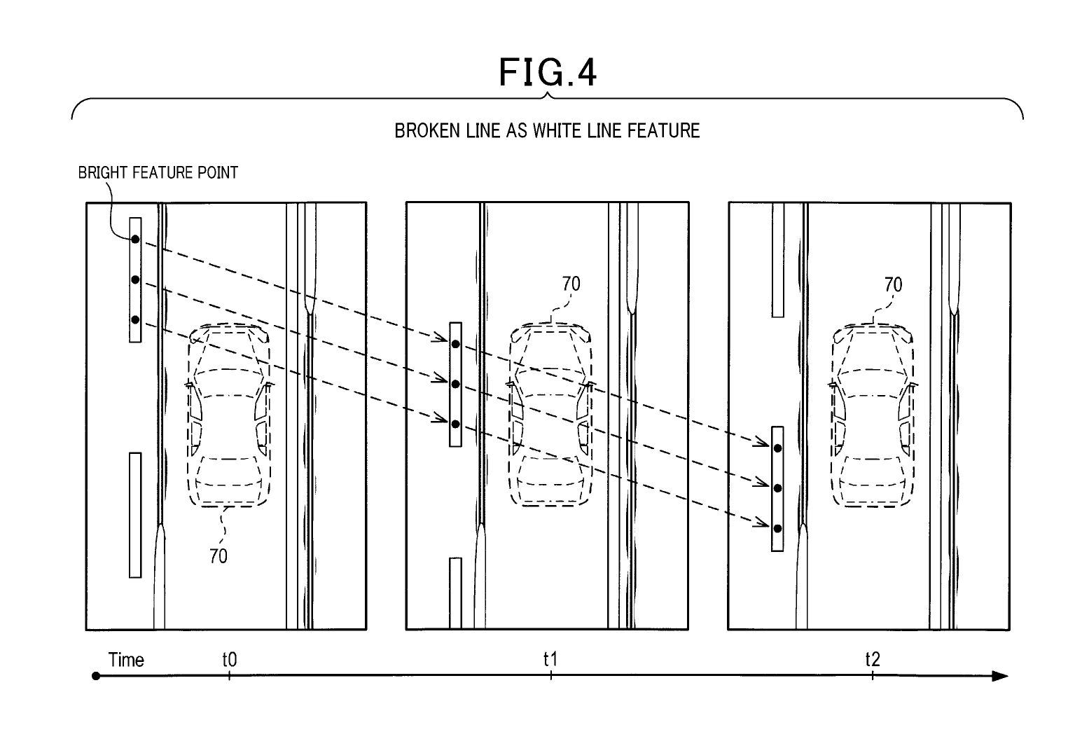

Next, the features of the broken white line, the solid white and the road surface reflection area are described, referring to FIG. 4 to FIG. 6.

A schematic view showing the bird's eye view image at each time point, which are the respective, time point t0, time point t1 and time point t2 are shown in FIG. 4 to FIG. 6. The time point t1 is at a time where a period ΔT has elapsed from the time point t0, and the time point t2 is at a time where the ΔT elapsed from the time point t1. In these figures, two or more frames successively selected show a direction of the vehicle 70 forward in a forward direction with time, flowing from a front end to a rear end thereof. Each frame from time point t0 to t2 is referred to respectively as frame 0 to frame 2, hereon. The period ΔT is a preset period, which is a sufficiently short period so that a relative position of the sunlight which is the light source and a position of the vehicle 70 can be considered constant. More specifically, the period ΔT is sufficiently short so that a relative position of sunlight and the cameras 11 to 14 is considered to be constant. The period ΔT may also be a period longer than the captured time interval of cameras 11 to 14. The frames 0 and 1 may be bird's eye view images each produced from camera images captured continuously, or bird's eye view images each produced from the camera images which are not captured continuously.

Among, the feature points showing feature areas of the road surface, feature points showing an area brighter than the road surface are bright feature points. The bright features points are points which are determined to have a higher luminance than a given threshold. As shown in the frames 0 to 2 in FIG. 4, the bright feature points are detected in different positions when the bright feature points represent broken white lines. The bright feature points representing the broken white lines are detected in different positions between the captured frames due to movement of the vehicle 70. More specifically, these bright feature points are detected in a position which changes according to movement of the vehicle 70 in a direction towards the rear and in a same width direction thereof.

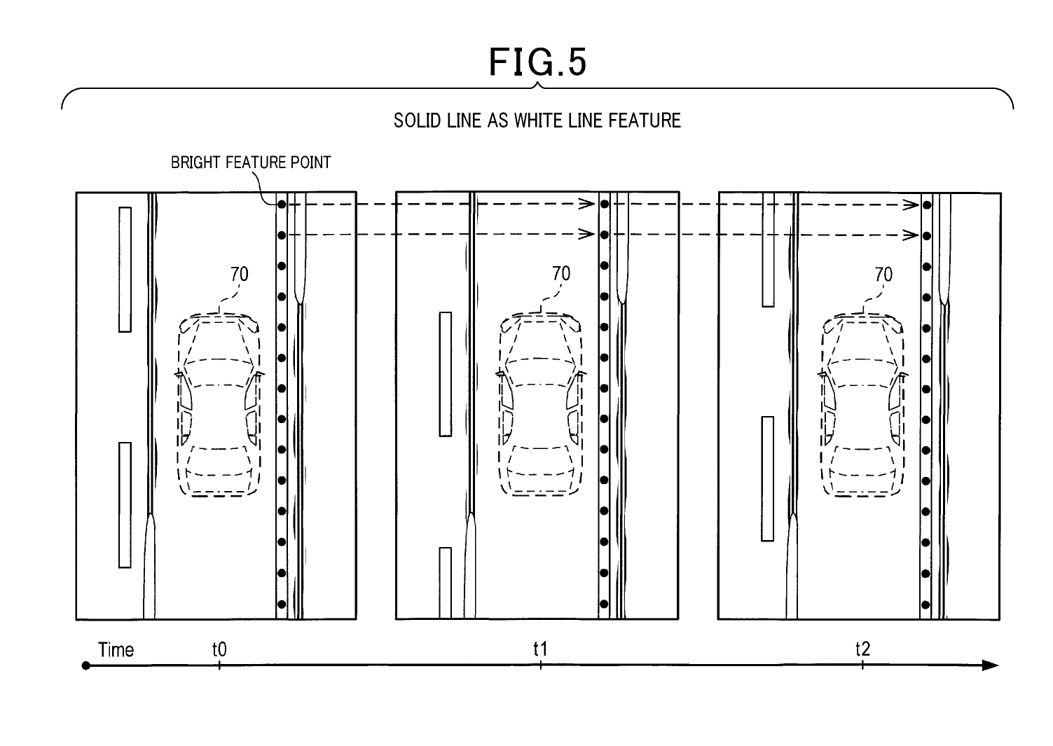

In contrast, the bright feature points representing the solid white lines, are the bright feature points detected in a same lateral direction and longitudinal direction of the vehicle 70 travelling in a forward direction, as shown in the frames 0 to 2 in FIG. 5. That is, although the frames flow towards the rear direction of the vehicle 70 with time, the solid white line appears in the same position between frames, thus the bright feature points are also detected in the same position between the frames.

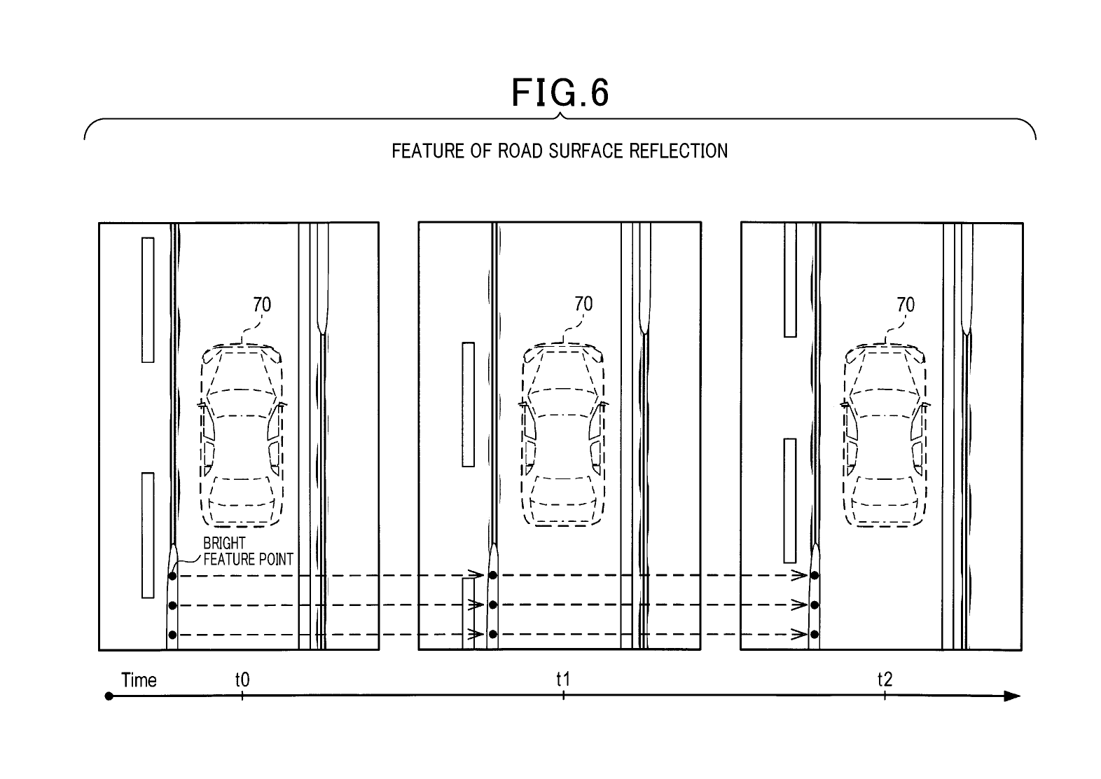

When the bright feature points indicate a reflected area on a road surface, the bright feature points are detected at the same lateral and longitudinal direction of the vehicle 70 in frames 0 to 2, as shown in FIG. 6. If the relative position of sunlight and the cameras 11 to 14 is fixed, the road surface reflection region is detected in the same position between frames, since the road surface reflection occurs in the same position, even though the frames are different. Additionally, from the relative position of sunlight and the cameras 11 to 14, the road surface reflection area is generally not formed from the rear end to the front end of the longitudinal direction in an image. In contrast, a length of a straight white line is the length of an image in the forward direction of the vehicle. A length of a road surface reflection area detected from the image, is therefore shorter than the length of the is straight white line as a result.

It is noted that, if a moving amount of the vehicle 70 during the period ΔT and an interval of the broken white line are the same, the broken white line will also be detected in the same position in each captured frame, therefore, the period ΔT is set to a value so that the moving amount of the vehicle 70 and the interval of the white lines are not the same.

<Process>

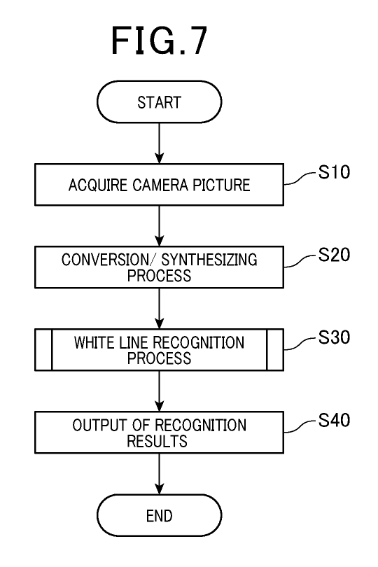

Next, a process of detection and outputting of the white line, using the different features of the white line and the road surface reflection will be described using the flow chart in FIG. 7.

Firstly, at step S10, the camera images captured by the cameras 11 to 14 are acquired, and converted to digital signals by sampling of the camera images acquired.

Subsequently, at step S20, the four digitally signalized camera images are converted to a bird's eye view image viewed from a preset virtual point, and the bird's eye view image showing a surroundings of the vehicle 70 is produced.

Next, at step S30, the white line is recognized from the bird's eye view image produced at step S20. Incidentally, the white line recognition process is described in detail later in the specification.

Next at step S40, results of the recognized white line detection are output to the vehicle controller 50 via a vehicle network and the process is completed.

It is noted that, in the present embodiment, a process at the step S10 is the process executed by input processing unit, and a process at step S20 is executed by the synthesizing processing unit 22. Additionally a process at step S30 is executed by the recognition processing unit 23 and a process at step S40 is executed by the output processing unit.

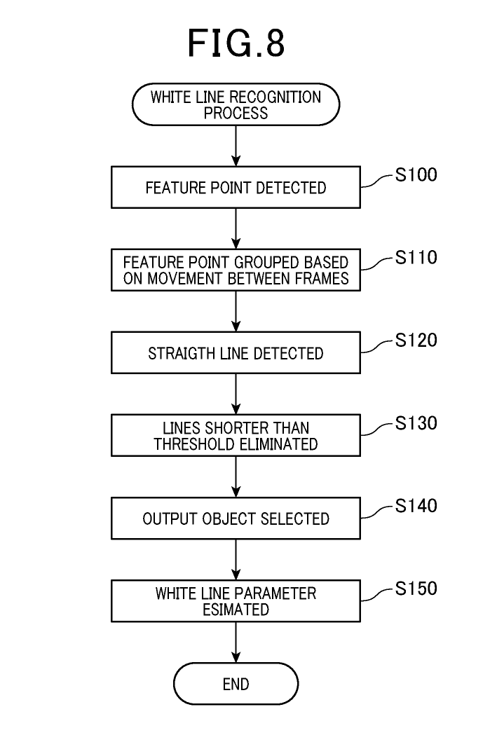

Next, a procedure of the white line recognition process is described referring to a flow chart in FIG. 8.

Firstly, at step S100, the bright feature points are detected from the bird's eye view produced at step S100. In the first embodiment, an edge point having a luminance value higher than the threshold value is determined as a bright feature point, and a Sobel filter, for example is applied to the bird's eye view image and the bright feature points are detected. The feature point detector detects bright feature points having pixels whose intensities are higher than a predetermined signal level and areas which are brighter than remaining areas on the road surface of a captured image.

Next in step S110, the bright features points which are detected on the basis of movement of the bright feature points between the frames are grouped. Specifically, a position of the bright feature points detected from the bird's eye view image produced at time point t11, which is a process point of this cycle, and a position of the bright feature points detected from the bird's eye view image produced at time point t10, which is a process point before an Nth cycle, are compared. If the positions of the bright feature points in the two frames are different, the bright feature points are grouped into a first group being a group of bright feature points representing broken white lines. In contrast, if the positions of the two feature points are the same, the bright feature points are grouped into a second group which is a group of bright feature points representing solid the white lines of a road surface reflection area. The number N is a positive integer more than one, and is a preset value.

Next, at step S120, straight lines are detected by applying Hough transformation to the bright feature points grouped into the groups at step S120.

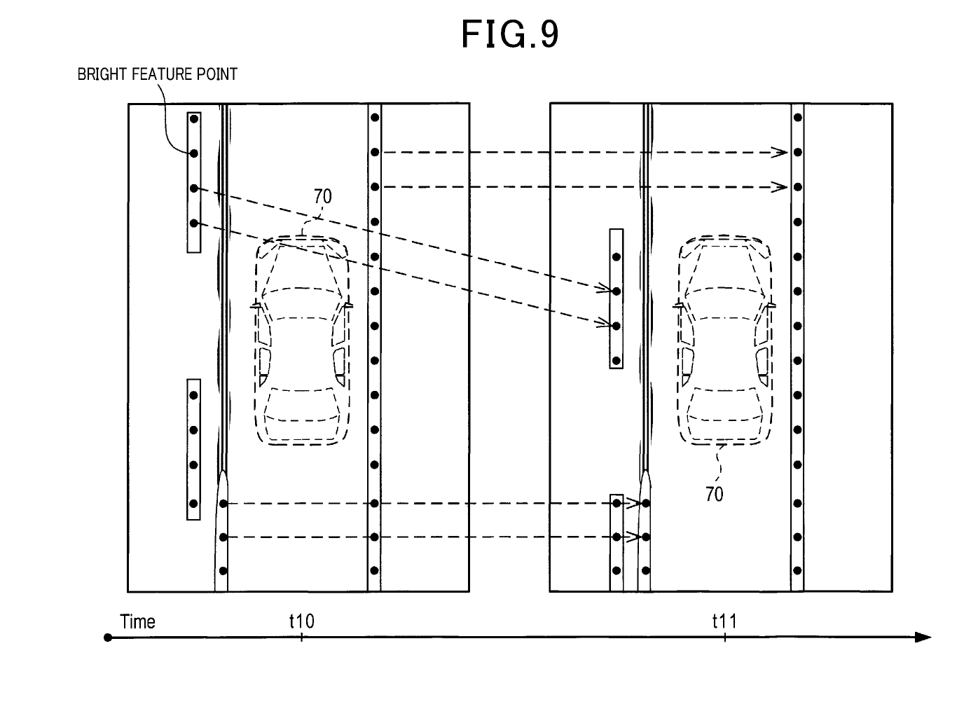

Next, at step S130, straight lines which are shorter than the preset threshold length are determined to be road surface reflection areas, among the straight lines detected from the bright feature points in the second group. The length of the threshold is shorter than the length of the produced bird's eye view image in a forward direction. For example, the length of threshold may be set to half the length of the forward direction thereof. In FIG. 9, straight lines that are shorter than the threshold value length and longer than the threshold value are determined, from the bright feature points in group 2. The straight lines that are shorter than the length of the threshold value are determined as being a road surface reflection.

Additionally, among the straight lines detected from the bright feature points in group 2, those which are determined as being the road surface reflection areas are eliminated as noise. Once noise is removed, remaining straight lines, and the straight lines detected from the bright feature points in group 1 are candidates for white lines.

Next in step S140, measured behavior of vehicle 70 is considered, and the white line candidates most similar to white lines among the candidates are selected for the left-side and the right-side of the vehicle 70. In the image shown in FIG. 9, broken white lines are selected on the left of the vehicle 70, and a solid white line is selected on the right of the vehicle 70.

Next, at step S150, a white line parameter is estimated from the white line candidates which are selected at step S140, and white lines are recognized. Incidentally, the white line parameter, for example, is a curvature of the white line, a vehicle line width, or an angle formed from the forward direction of the vehicle 70 and a tangent line direction. The process is then completed.

It is noted that a process at step S100 is process executed by the feature point detector, and processes from step S140 to S150 are executed by the reflection determination unit. Additionally, processes at steps S140 to S150 are executed by the division line recognition unit.

Effects

The following effects can be obtained from the first embodiment described above.

(1) The bright feature points can be grouped into the first group of the broken white lines, the second group of the solid white lines and the road surface reflection regions, based on movement of the bright feature points between frames. Additionally, the straight lines detected from the bright feature points in the second group, can be determined as the road surface reflection areas and the solid white lines, based on the length of the straight lines. As a result, by the elimination of the road surface reflection areas as noise, the white lines can be recognized with high precision.

### Second Embodiment

### Difference Between First and Second Embodiments

The basic configuration of the preferred second embodiment is the same as the first embodiment, therefore the description of the shared configuration is omitted, and the differences between the first and second embodiments mainly described. It is noted that symbols which are the same as the first embodiment show the same configuration also in the second embodiment.

Among the road surface reflection areas, the reflection area of a repair mark may be erroneously recognized as a white line quite easily, since such areas appear in line with the white lines. As a consequence, there is an increased demand particularly for enabling determination of the reflection areas of repair marks. The determination of the entire road surface reflection areas in the white line recognition process is described according to the first embodiment. In contrast, in the second embodiment determination of a reflection area of a repair mark, among the reflection areas in the white line recognition process will be described.

<Process>

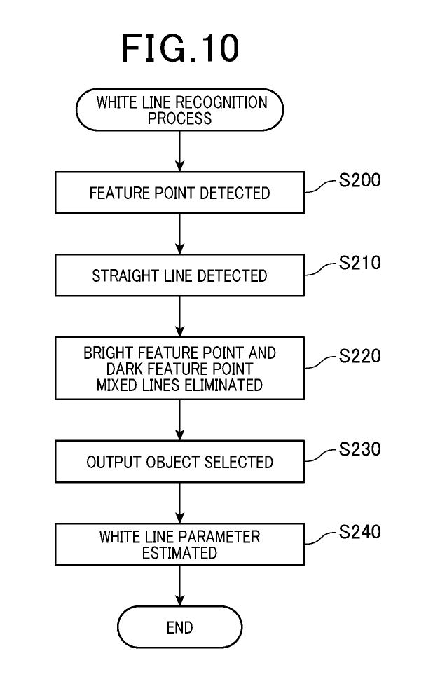

Next, with reference to FIG. 10, execution of a white line recognition process shown in FIG. 10 will be described. The process described is alternative to the white line recognition process according to the first embodiment shown in FIG. 8.

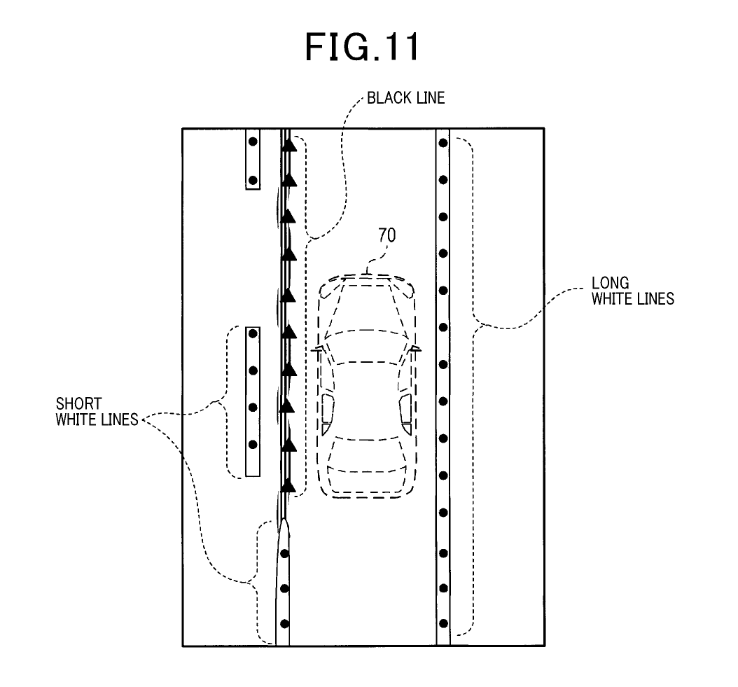

At step S200, the bright feature points described herein above, and dark feature points which represent areas that are darker than the road surface, are detected from the bird's eye view image produced. In the second embodiment, an edge point having a luminance value that is higher than the threshold value in a surrounding area is taken as a bright feature point, and an edge point having a luminance value lower than the threshold value in a surrounding area is taken as a dark feature point. The bright feature points and the dark features points are detected by applying a Sobel filer, for example to the bird's eye view image. As shown in FIG. 11, bright features points representing the broken white lines, the solid white lines and the reflection area of repair marks are detected. The dark features points showing non-reflection areas of repair marks are also detected.

Next, in step S210, the straight lines are detected by applying Hough transform, for example, to the detected bright feature points and dark feature points. A shown in FIG. 11, a straight line of bright features points only is detected in a position where the broken white lines and the solid white lines exist. In contrast, a bright area of a straight line of bright feature points and a dark area of a straight line of dark features points detected on the same straight line are detected in a position where a repair mark exists.

Next, at step S220, when a bright area and a dark area exist on the same straight line, the bright area is determined as a reflection area. At step S210, the bright areas determined as the reflection areas are eliminated from the straight lines detected, and the remaining straight lines are the white line candidates.

Next, at step S230, measured behavior of vehicle 70 is considered, and the white line candidate most similar to a white line, among the white line candidates, is selected for both the left-side and the right-side of the vehicle 70.

Next, at step 240, the white line parameter is estimated from the white line candidate selected at step S230, and the white line is recognized, after which the process is completed.

It is noted that, in the second embodiment, a process at the step S200 is executed by the feature point detector, and steps from S210 to step S220 are executed by the reflection determination unit. Additionally, a process from step S230 to step S240 is executed by a function of the white line recognition unit.

[Effects]

The following effects are obtained from the second embodiment described above.

(2) In an image, since the reflection area of a repair mark is brighter than the road surface and the non-reflection regions appear darker than the road surface, the respective bright and dark areas are detected on the same straight line. In contrast, also in an image, only bright areas are detected in positions of the broken white lines and the solid white lines. As a result, a bright area can be determined as being the reflection area of a repair mark, when the bright and dark areas exist on the same straight line. Furthermore, the reflection area of a repair mark is eliminated as noise, and the division line can be recognized with high precision.

### Third Embodiment

<Difference Between the Second and Third Embodiments>

A basic configuration of the third embodiment is the same as second embodiment, therefore a description of a shared configuration is omitted, and the difference between the second and third embodiments mainly described. It is noted that, symbols which are the same as the second embodiment show the same configuration also in the second embodiment.

In the second embodiment, the reflection area of a repair mark is determined using the arrangement of a bright area and a dark area.

In contrast, in the third embodiment, in addition to the arrangement of the bright area and the dark area, movement and the length of the straight line of the bright feature point between frames described in the first embodiment is used, that is the determination of the reflection area of a repair mark is different from the first embodiment.

<Process>

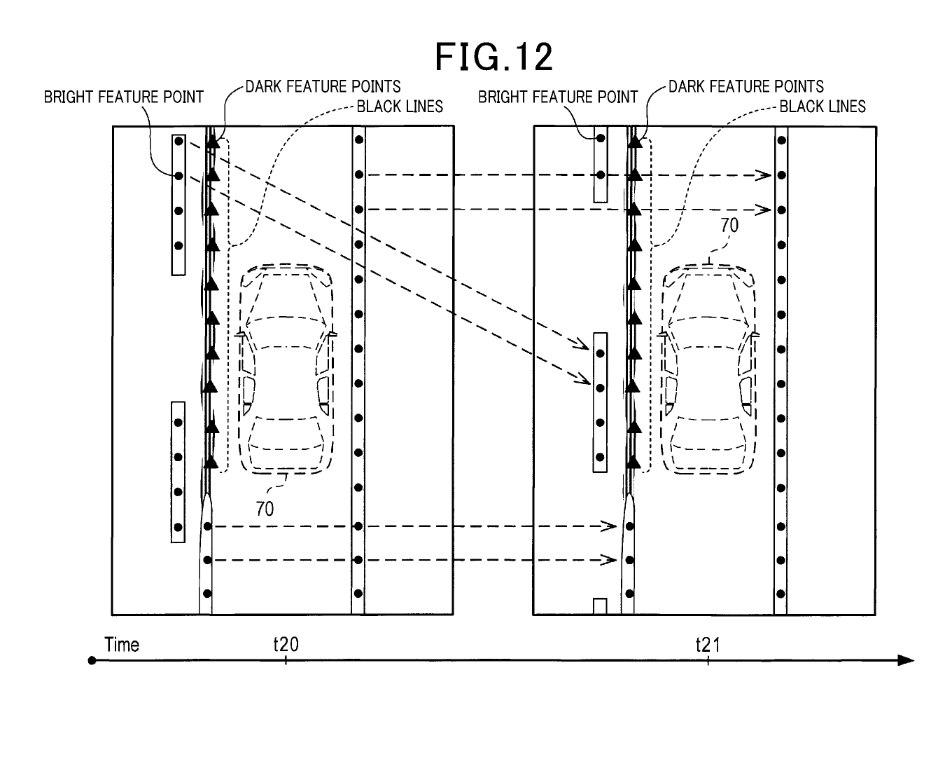

Next, a white line recognition process executed by the ECU-20 of the third embodiment is described. In the third embodiment, the step S110 in the flow chart shown FIG. 8 is executed between the process step of step S200 and S210 shown in FIG. 10. Specifically, as shown in FIG. 12, a detected position of the bright feature point from the bird's eye view image produced at the point t21 being this cycle process, and a detected position of the bright feature point is detected from the bird's eye view image produced at the point t20 before the N cycle are compared, and the bright feature points grouped accordingly. All of the dark feature points are grouped into group 2.

Next, at step S210, a straight line is detected for each group. In the second group, only bright areas are detected in a position where a solid white line exists, and both bright and dark areas are detected on the same straight line in a position where a repair mark exists, as shown in FIG. 12.

Next, at step S220, the process of eliminating straight lines which are shorter than the threshold length, at step S130 in FIG. 8, is added to the process of determination of straight lines as reflection areas. That is, in the process at step S220, straight lines among the straight lines in the second group are eliminated as noise when a dark area is detected on the same straight line as a bright area, and the bright area is shorter than a length of the threshold. The differences between the white line recognition process of the second embodiment and third embodiment are as described above.

<Effect>

In addition to the effects described in the second embodiment (2), further effects obtained from the third embodiment will now be described.

(3) There is also a case of a white line being provided on base material which is darker than the road surface. In such cases, a bright area and a dark area may be detected on a same straight line in the position of a broken white line, in an image. By using movement of the bright features between frames, in addition to the arrangement of the bright areas and dark areas, erroneous detection of broken white lines as road surface reflection areas can be decreased as a result. Also, by using the length of a bright area, in addition to the arrangement of the bright and dark areas, a reflection area of the road surface can be determined with high precision.

### OTHER EMBODIMENTS

Preferred embodiments of the present disclosure have been described, however the embodiments are not limited to the described. That is, various modification may be employed without departing from the scope of the disclosure.

(a) In the third embodiment the determination of a reflection area of a repair mark is executed by combining determination conditions of the first embodiment and the second embodiment. However, the reflection area of repair mark may be determined, for example, by using only a part of the determination conditions of the first embodiment combined with the determination conditions of the second embodiment. That is, the reflection area of a repair mark may be determined using the movement of bright features between the frames and the arrangement of the bright areas and the dark areas. In this case, the process of step S110, in which the bright feature points and the dark feature points are grouped, is executed between the process of step S200 and step S210, in the flow chart shown in FIG. 10. As a result, with reference to the broken white lines drawn on the dark base material on a road surface, erroneous determination of the broken white lines as reflection areas is decreased.

(b) Also, the reflection area of a repair mark may be determined by using the length of a straight line and the arrangement of the bright and dark areas. In this case, the straight line process at step S130 in FIG. 8, is added to the process of step S220 in the flow chart shown in FIG. 10, and a straight line satisfying both conditions is determined as a reflection area of a repair mark. As a result, a road surface reflection area can be determined with further enhanced precision, compared with only using an arrangement of the bright and dark areas as the determination condition.

(c) The feature point detected from an image is not limited to an edge point, as long as an element portrays a feature of the white line.

(d) The camera 10 may be provided with at least a front camera 11 and not necessarily configured of four cameras. If the camera 10 is configured of 1 camera, a camera image captured by the one camera is converted to produce a bird's eye view image.

(e) A configuring element preferred embodiment having a plurality of functions may be actualized by a plurality of configuring elements, and a configuring element having one function may also be actualized by a plurality of elements. Additionally, a plurality of configuring elements provided with a plurality of functions may be actualized as a single configuring element, and a plurality of elements provided with one function may also be actualized by one configuring element. A part of the configuration of the preferred embodiments may be omitted, and at least a part of the preferred embodiments may be added or substituted by the other embodiments. It is noted that all aspects included in the technical ideas specified by the scope of the claims are embodiments of the present disclosure.

(f) Finally, other than the division line recognition apparatus described herein, a program to allow a computer to function as a road surface detection apparatus, or the division line recognition apparatus may be used. Specifically, the present disclosure may be accomplished by various modes, for example, a non-transitory recording media, such as a semiconductor having the program recorded, a division line recognition method, and a road surface reflection determination method.

### DESCRIPTIONS OF SYMBOLS

10 . . . camera, 20 . . . ECU, 70 . . . vehicle.

What is claimed is:

1. An apparatus for recognizing division lines which recognizes a division line provided on a road surface indicating a vehicle lane, comprising:
a receiving unit which receives images captured by a camera mounted in a vehicle;
a feature point detector which detects bright feature points showing an area brighter than the road surface from the captured images;
a reflection determination unit which determines straight lines as road surface reflection areas, if the straight lines being the bright feature points detected in the same position between frames of the captured images captured at preset intervals, among the bright features points which are detected by the feature point detector, have a length of the straight line which is shorter than a preset threshold; and
a division line recognition unit which recognizes division lines from bright feature points which have the bright features points of straight lines shorter than the preset length of the threshold, determined by the reflection determination unit as the road surface reflection areas, removed therefrom, among the bright feature points detected by the bright feature point detector.

2. The apparatus for recognizing division lines according to claim 1, wherein:
the feature point detector detects dark feature points showing an area which is darker than the road surface from the captured image in addition to the bright feature points; and
the reflection determination unit determines the straight lines having the short length as the reflection areas when the dark feature points are arranged on the same straight line as the short straight line.

3. An apparatus for recognizing division lines which recognizes a division line provided on a road surface indicating a vehicle lane, comprising:
a receiving unit which receives images captured by a camera mounted in a vehicle;
a feature point detector which detects a feature point showing feature areas of the road surface from the captured images;
a reflection determination unit which determines the road surface reflection areas when,
a bright area being a line of bright feature points showing an area which is brighter than the road surface, among the feature points detected by the feature point detector; and
a dark area being a line of dark feature points showing an area darker than the road surface, among the feature points detected, exist on the same straight line; and
a division line recognition unit which recognizes a division line from the bright feature points having the bright areas determined as the road surface reflection areas by the reflection determination unit, removed therefrom, among the feature points detected by the feature point detector.

4. The apparatus of recognizing a division line according to claim 3, wherein:
the reflection determination unit detects the bright areas as being the road surface reflection areas, when the bright feature points of the bright areas are detected in the same position between frames of the captured images, captured at preset intervals.

5. The apparatus for recognizing a division line to claim 3, wherein:
the reflection determination unit determines the bright areas as road surface reflection areas, when a length of the bright area is shorter than a preset threshold length.

6. A method for recognizing division lines which recognizes a division line provided on a road surface indicating a vehicle lane, comprising steps of:
receiving images captured by a camera mounted in a vehicle;
detecting bright feature points showing an area brighter than the road surface from the captured images;
determining straight lines as road surface reflection areas, if the straight lines being the bright feature points detected in the same position between frames of the captured images captured at preset intervals, among the bright features points which are detected by the feature point detector, have a length of the straight line which is shorter than a preset threshold; and
recognizing division lines from bright feature points which have the bright feature points being straight lines shorter than the preset length of the threshold, determined as the road surface reflection areas by the reflection determination unit, removed therefrom, among the bright feature points detected by the bright feature point detector.
